(19) United States
(12) Patent Application Publication
(10) Pub. No.: US 2020/0061867 A1
(43) Pub. Date: Feb. 27, 2020

(54) Production device for green ecological hemp fiber integrated decoration wallboard

(71) Applicant: Huiting Ye, Guangzhou City (CN)

(72) Inventor: Huiting Ye, Guangzhou City (CN)

(21) Appl. No.: 16/673,965

(22) Filed: Nov. 5, 2019

(30) Foreign Application Priority Data
Jul. 25, 2019 (CN) 2019106783351

(51) Int. Cl. B28B 19/00

(52) U.S. Cl. CPC B28B 19/0092

(57) ABSTRACT

This invention discloses a production device for green ecological hemp fiber integrated decoration wallboard, including a machine body and an operation cavity with an upward opening arranged in the machine body, and a feeding hole communicated with the outside is formed in the operation cavity, and a roller cavity with an opening is formed in the feeding hole, and a roller is arranged in the roller cavity and the end wall of the roller cavity in a rotatable mode, and the feeding device drives the decoration plate to move towards the operation cavity through the rolling wheels; the device is able to perform equal-length cutting on the decoration plate during production of the green ecological hemp fiber integrated wall decoration plate, meanwhile, the equipment can automatically push the stacked decoration plates out of the equipment, the operation is convenient, the automation degree is high, and production and popularization are convenient.

### CROSS-REFERENCES TO RELATED APPLICATIONS

The present application claims priority from Chinese application No. 2019106783351 filed on Jul. 25, 2019 which is hereby incorporated by reference in its entirety.

### TECHNICAL FIELD

The present invention relates to the technical field of decoration materials production, in particular to a production device for green ecological hemp fiber integrated decoration wallboard.

### BACKGROUND OF THE INVENTION

When people carry out decoration in a room, a large amount of integrated wall decoration plates are often required to be utilized, the formaldehyde content of the traditional integrated wall decoration board is relatively high, so that the green ecological hemp fiber integrated wall decoration board is produced when the decoration board is subjected to extrusion forming and cooling, the decoration board is not easy to cut at equal length, so that the later binding and packaging efficiency is low; the traditional equipment is relatively low in efficiency and seriously affects the production progress of the veneer; therefore, a green ecological hemp fiber integrated wall decoration board production device is necessary to improve the problems.

### BRIEF SUMMARY OF THE INVENTION

The present invention provides a production device for green ecological hemp fiber integrated decoration wallboard to overcome the above problem.

According to the technical scheme, the technical scheme adopted by the invention is as follows: the invention discloses a green ecological hemp fiber integrated wall veneer production device, which comprises a machine body and an operation cavity which is arranged in the machine body and is provided with an upward opening, and a feeding hole communicated with the outside is formed in the left end wall of the operation cavity, and a roller cavity with an opening is formed in the top wall of the feeding hole, and a roller is arranged in the roller cavity and the end wall of the roller cavity in a rotatable mode, and the feeding device drives the decoration plate to move towards the inner side of the operation cavity by utilizing the rolling wheels to rotate, the inner opening of the bottom wall of the feeding hole is upwards provided with a cutting cavity which is positioned on the right side of the rolling wheel cavity, a sliding frame is arranged in the cutting cavity in a front-back sliding mode, and a cutting device used for cutting the veneer is arranged in the sliding frame, and a first switching cavity is formed in the top wall of the sliding frame, a first sliding block is arranged in the first switching cavity in a slidable mode, and a first motor is arranged in the first sliding block, and a first spline sleeve and a second spline sleeve are fixedly arranged at the extending tail ends of the output axial direction of the first motor, the left end wall of the first switching cavity is internally provided with a first power switching device which drives the first motor to switch and drive the feeding device and the cutting device to be switched in time, and a transmission cavity is formed in the bottom wall of the cutting cavity, and a pushing device for driving the push plate to move left and right in the operation cavity in a sliding mode is arranged in the transmission cavity, a second switching cavity is formed in the rear side end wall of the cutting cavity, and a suction cavity is formed in the inner opening of the rear side end wall of the second switching cavity in a forward direction, and a second sliding block is arranged in the suction cavity in a slidable mode, a second motor is fixedly arranged in the end wall of the front side of the second sliding block; a second power switching device for driving the pushing device to move relative to the sliding frame is arranged in the suction cavity; a sliding cavity with a leftward opening is formed in the right end wall of the operating cavity; a third sliding block is slidably arranged in the sliding cavity; a feeding auxiliary device is arranged in the third sliding block;

Beneficially, the feeding device comprises a gear cavity which is symmetrically arranged in the front end wall and the rear end wall of the roller cavity and the front end wall and the rear end wall of the cutting cavity, and a first rotating shaft penetrating through the roller cavity is rotationally arranged between the front gear cavity and the rear gear cavity, and the roller is fixedly arranged on the outer surface of the first rotating shaft, and a first gear is fixedly arranged at the tail end of the first rotating shaft in the gear cavity, and a second rotating shaft is rotationally arranged between the gear cavity and the cutting cavity, and a second gear meshed with the first gear is fixedly arranged at the tail end of the second rotating shaft in the gear cavity, and a third spline sleeve is fixedly arranged at the tail end of the second rotating shaft in the cutting cavity, a cavity is formed in the left end wall of the first switching cavity, and a first spline shaft is arranged in the cavity in a rotatable mode, a first bevel gear is fixedly arranged on the outer surface of the first spline shaft in the cavity, a second spline shaft is rotationally arranged between the cavity and the first switching cavity, and a second bevel gear meshed with the first bevel gear is fixedly arranged at the tail end of the second spline shaft in the cavity.

Beneficially, the cutting device comprises a first threaded hole and a second threaded hole, wherein the first threaded hole is formed in the sliding frame in a front-and-back manner, and a first threaded rod extending forwards and backwards is arranged in the first threaded hole in a threaded manner, the tail end of the front and rear sides of the first threaded rod extends into the second switching cavity, a third gear is fixedly arranged at the tail end of the first threaded rod, a rotating cavity is formed in the right end wall of the first switching cavity, a third spline shaft is rotationally arranged between the rotating cavity and the first switching cavity, a cutting knife is fixedly arranged at the tail end of the third spline shaft in the rotating cavity, and a groove aligned with the rotating cavity is formed in the top wall of the feeding opening.

Beneficially, the first power switching device comprises a meshing cavity arranged in the left end wall of the first switching cavity and a left and right through second threaded hole arranged in the first sliding block, the tail end of the left side of the second threaded rod extends into the meshing cavity, a fourth gear is fixedly arranged at the tail end of the second threaded rod, a first torsion spring is elastically arranged between the second threaded rod and the end wall of the meshing cavity, a first sliding hole extending forwards and backwards is symmetrically arranged in the end wall of the meshing cavity, and a first rack meshed with the fourth gear is slidably arranged in the first sliding hole.

Beneficially, the pushing device comprises a torsional spring cavity arranged in the right end wall of the transmission cavity, and a spline sleeve penetrating through the torsional spring cavity is rotationally arranged between the transmission cavity and the operating cavity, a third bevel gear is fixedly arranged on the outer surface of the spline sleeve in the transmission cavity, and a third rotating shaft is rotationally arranged between the transmission cavity and the second switching cavity, and a fifth gear is fixedly arranged at the tail end of the third rotating shaft in the second switching cavity, a fourth bevel gear meshed with the third bevel gear is fixedly arranged at the tail end of the third rotating shaft in the transmission cavity, a second torsion spring is elastically arranged between the spline sleeve in the torsional spring cavity and the end wall of the torsional spring cavity, a third threaded hole is formed in the right end wall of the spline sleeve, and a third threaded rod fixedly connected with the push plate is in threaded connection with the third threaded hole.

Beneficially, the second power switching device comprises a permanent magnet fixedly arranged in the bottom wall of the second sliding block and an electromagnet arranged in the bottom wall of the suction cavity, a jacking spring is elastically arranged between the second sliding block and the bottom wall of the suction cavity, and a sixth gear meshed with the third gear is fixedly arranged at the tail end of the output shaft of the second motor.

Beneficially, the feeding auxiliary device comprises a left through groove and a right through groove which are arranged in the third sliding block, sliding grooves are symmetrically formed in the front end wall and the rear end wall of the through groove, and a third rack is arranged in the sliding groove in a slidable mode, and a second sliding hole is formed in the right end wall of the third sliding block in a front-back symmetry mode, and a fourth rack is slidably arranged in the second sliding hole, and a first reset device is elastically arranged between the end wall of the fourth rack and the end wall of the third sliding block, and a through hole is communicated between the second sliding hole and the sliding groove, a fifth gear meshed with the fourth rack and the third rack is arranged in the through hole in a rotatable mode, a pushing groove with leftward opening is formed in the top wall of the sliding groove, a sensor electrically connected with the electromagnet is fixedly arranged in the bottom wall of the third rack, a discharging opening communicated with the outside is formed in the right end wall of the sliding cavity, and a second resetting device is elastically arranged between the third sliding block and the upper and lower end walls of the sliding cavity.

The beneficial effects of the device are as follows: the device can be used for performing equal-length cutting on the veneer during production of the green ecological hemp fiber integrated wall veneer; meanwhile, the equipment can stack the cut veneers, so that later binding is facilitated; meanwhile, the laminated veneer can be automatically pushed out of equipment by the equipment, so that the equipment is convenient to operate, high in automation degree and convenient to produce and popularize and use.

### BRIEF DESCRIPTION OF THE DRAWINGS

For better explaining the technical proposal in the present invention embodiments or the prior art, the drawings to be used in the description of the embodiments or the prior art will be briefly described below.

FIG. 1 is a schematic view showing the overall structure of a production device for green ecological hemp fiber integrated decoration wallboard of the present invention;

FIG. 2 is a schematic enlarged view of A of FIG. 1;

FIG. 3 is a schematic structural diagram of B-B in FIG. 1;

FIG. 4 is a schematic structural diagram of C-C in FIG. 1;

FIG. 5 is a schematic structural diagram of D-D in FIG. 2.

### DETAILED DESCRIPTION OF THE INVENTION

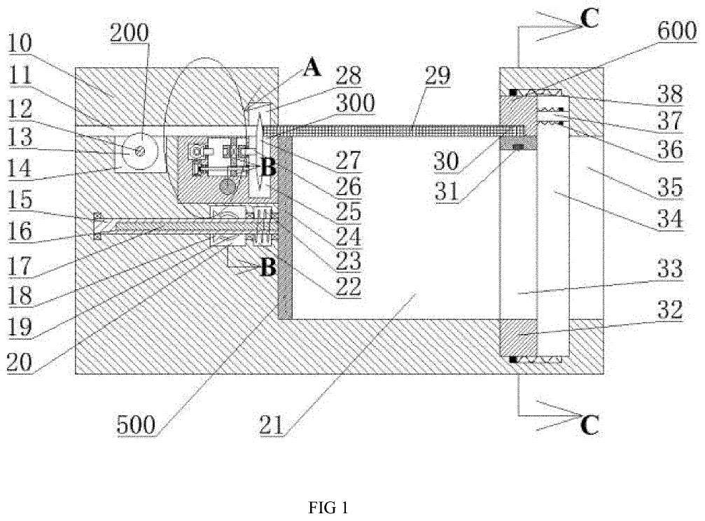

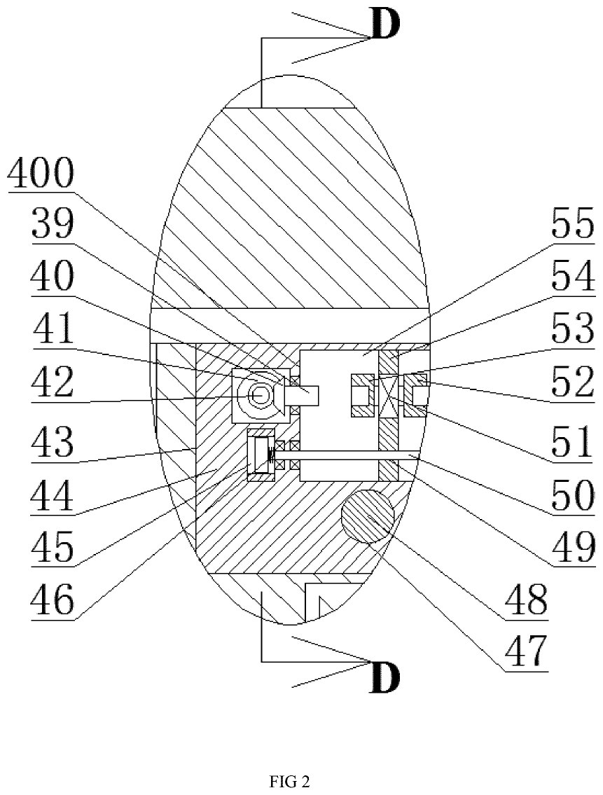

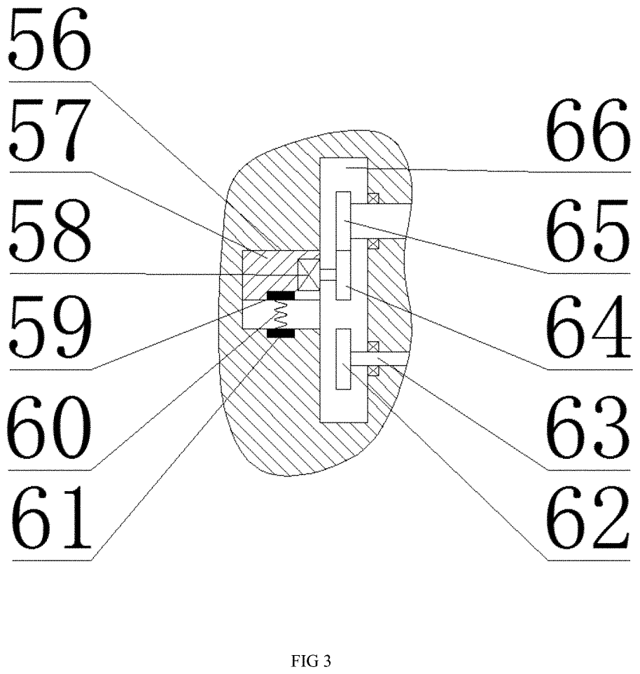

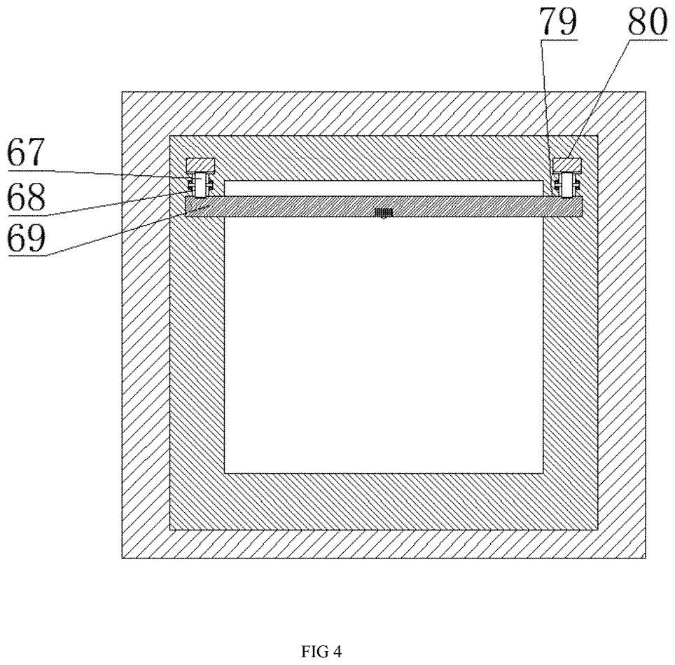

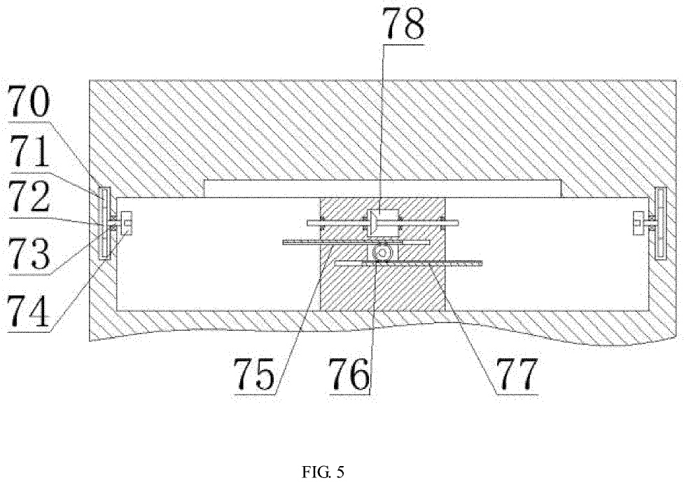

The invention will be described in detail below referring to FIG. 1 to FIG. 5. For better explanation, the orientations described hereinafter are defined as follows: directions of up, down, left, right, front and rear in the text are identical to the directions of up, down, left, right, front and rear of FIG. 1.

A production device for green ecological hemp fiber integrated decoration wallboard according to the present invention, includes the green ecological hemp fiber integrated wall veneer production device is described in connection with FIGS. 1-5., wherein the machine body 10 and an operating cavity 21 with an upward opening are formed in the machine body 10, and a feeding port 11 communicated with the outside is formed in the left end wall of the operating cavity 21, and a roller cavity 14 with an opening is formed in the top wall of the feeding port 11, and a roller 13 is arranged in the roller cavity 14 and the end wall of the roller cavity 14 in a rotatable mode, the feeding device 200 is used for driving the decoration plate 29 to move towards the operation cavity 21 by means of the rolling wheels 13, the inner opening of the bottom wall of the feeding hole 11 is upwards provided with a cutting cavity 43 located on the right side of the rolling wheel cavity 14, a sliding frame 44 is arranged in the cutting cavity 43 and can slide back and forth in the cutting cavity 43, a cutting device 300 used for cutting the veneer 29 is arranged in the sliding frame 44, a first switching cavity 55 is formed in the top wall of the sliding frame 44, a first sliding block 54 is slidably arranged in the first switching cavity 55, a first motor 51 is arranged in the first sliding block 54, and a first spline sleeve 53 and a second spline sleeve 52 are fixedly arranged at the extending tail ends of the output axial direction of the first motor 51, the left end wall of the first switching cavity 55 is internally provided with a first power switching device 400 for driving the first motor 51 to switch in time and drive the feeding device 200 to be connected with the cutting device 300, and a transmission cavity 20 is formed in the bottom wall of the cutting cavity 43, and a pushing device 500 for driving the push plate 24 to move left and right in the operation cavity 21 is arranged in the transmission cavity 20, a second switching cavity 66 is formed in the rear side end wall of the cutting cavity 43, the inner opening of the rear side end wall of the second switching cavity 66 is provided with a suction cavity 56, and a second sliding block 57 is slidably arranged in the suction cavity 56, and a second motor 58 is fixedly arranged in the front end wall of the second sliding block 57, a second power switching device 600 for driving the pushing device 500 to move relative to the sliding frame 44 is arranged in the suction cavity 56, a sliding cavity 34 with a leftward opening is formed in the right end wall of the operating cavity 21, a third sliding block 32 is slidably arranged in the sliding cavity 34, and a feeding auxiliary device 700 is arranged in the third sliding block 32.

Beneficially, the feeding device 200 comprises a gear cavity 70 which is symmetrically arranged in the front end wall and the rear end wall of the cutting cavity 43, and a first rotating shaft 12 penetrating through the roller cavity 14 is rotationally arranged between the front and rear gear cavities 70, the roller 13 is fixedly arranged on the outer surface of the first rotating shaft 12, a first gear 71 is fixedly arranged at the tail end of the first rotating shaft 12 in the gear cavity 70, a second rotating shaft 73 is rotationally arranged between the gear cavity 70 and the cutting cavity 43, a second gear 72 meshed with the first gear 71 is fixedly arranged at the tail end of the second rotating shaft 73 in the gear cavity 70, a third spline sleeve 74 is fixedly arranged at the tail end of the second rotating shaft 73 in the cutting cavity 43, a cavity 78 is formed in the left end wall of the first switching cavity 55, a first spline shaft 42 is rotatably arranged in the cavity 78, the front side and the rear side of the first spline shaft 42 penetrate through the sliding frame 44, and the tail end of the first spline shaft 42 extends out of the sliding frame 44, a first bevel gear 41 is fixedly arranged on the outer surface of the first spline shaft 42 in the cavity 78, a second spline shaft 39 is rotationally arranged between the cavity 78 and the first switching cavity 55, and a second bevel gear 40 meshed with the first bevel gear 41 is fixedly arranged at the tail end of the second spline shaft 39 in the cavity 78.

Beneficially, the cutting device 300 comprises a first threaded hole 47 which is arranged in the sliding frame 44 in a front-and-back manner, and the first threaded hole 47 is in threaded connection with a first threaded rod 48 extending forwards and backwards, the tail ends of the front and rear sides of the first threaded rod 48 extend into the second switching cavity 66, and a third gear 65 is fixedly arranged at the tail end of the first threaded rod 48, a rotating cavity 25 is formed in the right end wall of the first switching cavity 55, a third spline shaft 26 is rotationally arranged between the rotating cavity 25 and the first switching cavity 55, a cutting knife 27 is fixedly arranged at the tail end of the third spline shaft 26 in the rotating cavity 25, and a groove 28 aligned with the rotating cavity 25 is formed in the top wall of the feeding opening 11.

Beneficially, the first power switching device 400 comprises a meshing cavity 45 arranged in the left end wall of the first switching cavity 55 and a left and right through second threaded hole 49 arranged in the first sliding block 54, and a second threaded rod 50 is in threaded connection with the second threaded hole 49, a fourth gear 76 is fixedly arranged at the tail end of the left end of the second threaded rod 50, a fourth gear 76 is fixedly arranged at the tail end of the second threaded rod 50, a first torsion spring 46 is elastically arranged between the second threaded rod 50 and the end wall of the meshing cavity 45, a first sliding hole 75 extending forwards and backwards is symmetrically arranged in the end wall of the meshing cavity 45, and a first rack 77 meshed with the fourth gear 76 is slidably arranged in the first sliding hole 75.

Beneficially, the pushing device 500 comprises a torsional spring cavity 22 arranged in the right end wall of the transmission cavity 20, and a spline sleeve 15 penetrating through the torsional spring cavity 22 is rotationally arranged between the transmission cavity 20 and the operation cavity 21, a third bevel gear 18 is fixedly arranged on the outer surface of the spline sleeve 15 in the transmission cavity 20, and a third rotating shaft 63 is rotationally arranged between the transmission cavity 20 and the second switching cavity 66, a fifth gear 62 is fixedly arranged at the tail end of the third rotating shaft 62 in the second switching cavity 66, a fourth bevel gear 19 meshed with the third bevel gear 18 is fixedly arranged at the tail end of the third rotating shaft 63 in the transmission cavity 20, a second torsion spring 23 is elastically arranged between the spline sleeve 15 in the torsional spring cavity 22 and the end wall of the torsional spring cavity 22, a third threaded hole 16 is formed in the right end wall of the spline sleeve 15, and a third threaded rod 17 fixedly connected with the push plate 24 is in threaded connection with the third threaded hole 16.

Beneficially, the second power switching device 600 comprises a permanent magnet 59 fixedly arranged in the bottom wall of the second sliding block 57 and an electromagnet 61 arranged in the bottom wall of the suction cavity 56, a jacking spring 60 is elastically arranged between the second sliding block 57 and the bottom wall of the suction cavity 56, and a sixth gear 64 meshed with the third gear 65 is fixedly arranged at the tail end of the output shaft of the second motor 58.

Beneficially, the feeding auxiliary device 700 comprises a left through groove 33 and a right through groove 33 which are arranged in the third sliding block 32, sliding grooves 79 are symmetrically formed in the front end wall and the rear end wall of the through groove 33, a third rack 69 is slidably arranged in the sliding groove 79, and second sliding holes 80 are symmetrically formed in the left side and the right side of the right end wall of the third sliding block 32, and a fourth rack 37 is slidably arranged in the second sliding hole 80, and a first reset device 36 is elastically arranged between the end wall of the fourth rack 37 and the end wall of the third sliding block 32, and a through hole 68 is communicated between the second sliding hole 80 and the sliding groove 79, a seventh gear 67 meshed with the fourth rack 37 and the third rack 69 is rotatably arranged in the through hole 68, and a pushing groove 30 with a leftward opening is formed in the top wall of the sliding groove 79, a sensor 31 electrically connected with the electromagnet 61 is fixedly arranged in the bottom wall of the third rack 69, a discharging opening 35 communicated with the outside is formed in the right end wall of the sliding cavity 34, and a second resetting device 38 is elastically arranged between the third sliding block 32 and the upper and lower end walls of the sliding cavity 34.

The fixed connection method disclosed by the embodiment comprises, but is not limited to, bolt fixation, welding and other methods.

Sequence of mechanical actions of the entire apparatus.

firstly, when the equipment works, and one end of the green ecological hemp fiber integrated wall decoration plate is extruded and cooled, and one end of the green ecological hemp fiber integrated wall decoration plate extends into the feeding port 11 and above the roller 13, at the moment, the second motor 58 is started to drive the sixth gear 64 to rotate, so as to drive the third gear 65 to rotate, so as to drive the first threaded rod 48 to rotate, so as to drive the sliding frame 44 to move to the last side of the cutting cavity 43, at the moment, the first spline shaft 42 is inserted into the third spline sleeve 74 on the rear side, and meanwhile, the first rack 77 on the rear side is subjected to the jacking forward movement of the rear side wall body of the cutting cavity 43, so as to drive the fourth gear 76 to rotate, so as to drive the second threaded rod 49 to rotate, so as to drive the first sliding block 54 to move leftwards, so as to drive the first spline sleeve 53 to be in spline connection with the second spline shaft 39, at the moment, the second motor 58 is closed to start the first motor 51, the first motor 51 drives the first spline sleeve 53 to rotate so as to drive the second spline shaft 39 to rotate so as to drive the second bevel gear 40 and the first bevel gear 41 to rotate;

secondly, when the decorative plate 29 is in contact with the right end wall of the pushing groove 30, closing the first motor 15, and the second motor 58 is started to drive the sixth gear 64 to rotate, so as to drive the third gear 65 to rotate, so as to drive the first threaded rod 48 to rotate, so as to drive the sliding frame 44 to move forward, and at the moment, the first rack 77 loses the top pressure of the side wall body of the cutting cavity 43, the first torsion spring 46 releases elastic potential energy, so as to drive the second threaded rod 50 to rotate reversely, the first rack 77 is reset under the action of the fourth gear 76, and the first motor 51 is started to drive the second spline sleeve 52 to rotate so as to drive the third spline shaft 26 to rotate so as to drive the cutter 27 to rotate;

thirdly, when the plate is cut, the sliding frame 44 continues to move forward, at the moment, the first spline shaft 42 is inserted into the third spline sleeve 74 on the front side, and meanwhile, the first rack 77 on the front side is subjected to the jacking forward movement of the front side wall body of the cutting cavity 43, so as to drive the fourth gear 76 to rotate, so as to drive the second threaded rod 49 to rotate, so as to drive the first sliding block 54 to move leftwards, so as to drive the first spline sleeve 53 to be in spline connection with the second spline shaft 39, at the moment, the second motor 58 is closed to start the first motor 51, the first motor 51 drives the first spline sleeve 53 to rotate, so as to drive the second spline shaft 39 to rotate, so as to drive the second bevel gear 40 and the first bevel gear 41 to rotate, at the moment, the first spline shaft 42 rotates to drive the third spline sleeve 74 to rotate, so as to drive the second gear 72 and the first gear 71 to rotate, so as to drive the roller wheel 13 to rotate, so as to drive the decoration plate 29 to move rightwards, and the decorative board 29 moves rightwards to extrude the cut decorative board 29 to move rightwards, and at the moment, the cut decorative plate 29 pushes the third sliding block 32 to move rightwards, so as to drive the third rack 69 to move rightwards; when the cut veneer 69 is pushed to the right side edge of the push plate 24, the third rack 69 moves rightwards to be separated from the veneer 69, and at the moment, the veneer 69 falls to the bottom of the operation cavity 21 under the action of gravity;

repeating the above steps, when the decoration plate 21 in the operation cavity 21 is stacked to be flush with the sensor 31, the electromagnet 61 is electrically connected with the electromagnet 61, and the electromagnet 61 is used for controlling the electromagnet 61 to be electrified to attract the permanent magnet 59, at the moment, the second sliding block 57 moves downwards, so as to drive the sixth gear 64 to move downwards to be meshed with the fifth gear 62, the second motor 58 is started to drive the sixth gear 64 to rotate, so as to drive the fifth gear 62 to rotate, so as to drive the fourth bevel gear 19 to rotate, so as to drive the third bevel gear 18 to rotate, so as to drive the threaded sleeve 15 to rotate, so as to drive the third threaded rod 17 to move rightwards, so as to drive the push plate 24 to move rightwards, so that the cut decorative plate 21 is driven to move right out of the operation cavity 21, and the working personnel can move out the cut veneers 21 at the moment, at the moment, the sensor 31 cannot sense the decoration plate, the second sliding block 57 moves upwards to drive the sixth gear 64 to be separated from the fifth gear 62 at the moment, the threaded sleeve 15 reversely rotates under the action of the second torsion spring 23 so as to drive the push plate 24 to reset at the moment, the equipment returns to the initial state, and the green ecological hemp fiber integrated wall decoration plate after extrusion forming and cooling is conveniently cut.

The above is only the specific embodiment of the invention, but the scope of the invention is not limited thereto, and any changes or substitutions that are not thought of by the creative work are included in the scope of the invention.

1. A production device for green ecological hemp fiber integrated decoration wallboard, comprising a machine body and an operation cavity which is arranged in the machine body and is provided with an upward opening,
wherein, and a feeding hole communicated with the outside is formed in the left end wall of the operation cavity, and a roller cavity with an opening is formed in the top wall of the feeding hole, and a roller is arranged in the roller cavity and the end wall of the roller cavity in a rotatable mode, and the feeding device drives the decoration plate to move towards the inner side of the operation cavity by utilizing the rolling wheels to rotate, the inner opening of the bottom wall of the feeding hole is upwards provided with a cutting cavity which is positioned on the right side of the rolling wheel cavity, a sliding frame is arranged in the cutting cavity in a front-back sliding mode, and a cutting device used for cutting the veneer is arranged in the sliding frame, and a first switching cavity is formed in the top wall of the sliding frame, a first sliding block is arranged in the first switching cavity in a slidable mode, and a first motor is arranged in the first sliding block, and a first spline sleeve and a second spline sleeve are fixedly arranged at the extending tail ends of the output axial direction of the first motor, the left end wall of the first switching cavity is internally provided with a first power switching device which drives the first motor to switch and drive the feeding device and the cutting device to be switched in time, and a transmission cavity is formed in the bottom wall of the cutting cavity, and a pushing device for driving the push plate to move left and right in the operation cavity in a sliding mode is arranged in the transmission cavity, a second switching cavity is formed in the rear side end wall of the cutting cavity, and a suction cavity is formed in the inner opening of the rear side end wall of the second switching cavity in a forward direction, and a second sliding block is arranged in the suction cavity in a slidable mode, a second motor is fixedly arranged in the end wall of the front side of the second sliding block; a second power switching device for driving the pushing device to move relative to the sliding frame is arranged in the suction cavity; a sliding cavity with a leftward opening is formed in the right end wall of the operating cavity; a third sliding block is slidably arranged in the sliding cavity; a feeding auxiliary device is arranged in the third sliding block.

2. The production device for green ecological hemp fiber integrated decoration wallboard according to claim 1, wherein the feeding device comprises a gear cavity which is symmetrically arranged in the front end wall and the rear end wall of the roller cavity and the front end wall and the rear end wall of the cutting cavity, and a first rotating shaft penetrating through the roller cavity is rotationally arranged between the front gear cavity and the rear gear cavity, and the roller is fixedly arranged on the outer surface of the first rotating shaft, and a first gear is fixedly arranged at the tail end of the first rotating shaft in the gear cavity, and a second rotating shaft is rotationally arranged between the gear cavity and the cutting cavity, and a second gear meshed with the first gear is fixedly arranged at the tail end of the second rotating shaft in the gear cavity, and a third spline sleeve is fixedly arranged at the tail end of the second rotating shaft in the cutting cavity, a cavity is formed in the left end wall of the first switching cavity, and a first spline shaft is arranged in the cavity in a rotatable mode, a first bevel gear is fixedly arranged on the outer surface of the first spline shaft in the cavity, a second spline shaft is rotationally arranged between the cavity and the first switching cavity, and a second bevel gear meshed with the first bevel gear is fixedly arranged at the tail end of the second spline shaft in the cavity.

3. The production device for green ecological hemp fiber integrated decoration wallboard according to claim 1, wherein the cutting device comprises a first threaded hole and a second threaded hole, wherein the first threaded hole is formed in the sliding frame in a front-and-back manner, and a first threaded rod extending forwards and backwards is arranged in the first threaded hole in a threaded manner, the tail end of the front and rear sides of the first threaded rod extends into the second switching cavity, a third gear is fixedly arranged at the tail end of the first threaded rod, a rotating cavity is formed in the right end wall of the first switching cavity, a third spline shaft is rotationally arranged between the rotating cavity and the first switching cavity, a cutting knife is fixedly arranged at the tail end of the third spline shaft in the rotating cavity, and a groove aligned with the rotating cavity is formed in the top wall of the feeding opening.

4. The production device for green ecological hemp fiber integrated decoration wallboard according to claim 1, wherein the first power switching device comprises a meshing cavity arranged in the left end wall of the first switching cavity and a left and right through second threaded hole arranged in the first sliding block, the tail end of the left side of the second threaded rod extends into the meshing cavity, a fourth gear is fixedly arranged at the tail end of the second threaded rod, a first torsion spring is elastically arranged between the second threaded rod and the end wall of the meshing cavity, a first sliding hole extending forwards and backwards is symmetrically arranged in the end wall of the meshing cavity, and a first rack meshed with the fourth gear is slidably arranged in the first sliding hole.

5. The production device for green ecological hemp fiber integrated decoration wallboard according to claim 1, wherein the pushing device comprises a torsional spring cavity arranged in the right end wall of the transmission cavity, and a spline sleeve penetrating through the torsional spring cavity is rotationally arranged between the transmission cavity and the operating cavity, a third bevel gear is fixedly arranged on the outer surface of the spline sleeve in the transmission cavity, and a third rotating shaft is rotationally arranged between the transmission cavity and the second switching cavity, and a fifth gear is fixedly arranged at the tail end of the third rotating shaft in the second switching cavity, a fourth bevel gear meshed with the third bevel gear is fixedly arranged at the tail end of the third rotating shaft in the transmission cavity, a second torsion spring is elastically arranged between the spline sleeve in the torsional spring cavity and the end wall of the torsional spring cavity, a third threaded hole is formed in the right end wall of the spline sleeve, and a third threaded rod fixedly connected with the push plate is in threaded connection with the third threaded hole.

6. The production device for green ecological hemp fiber integrated decoration wallboard according to claim 1, wherein the second power switching device comprises a permanent magnet fixedly arranged in the bottom wall of the second sliding block and an electromagnet arranged in the bottom wall of the suction cavity, a jacking spring is elastically arranged between the second sliding block and the bottom wall of the suction cavity, and a sixth gear meshed with the third gear is fixedly arranged at the tail end of the output shaft of the second motor.

7. The production device for green ecological hemp fiber integrated decoration wallboard according to claim 1, wherein the feeding auxiliary device comprises a left through groove and a right through groove which are arranged in the third sliding block, sliding grooves are symmetrically formed in the front end wall and the rear end wall of the through groove, and a third rack is arranged in the sliding groove in a slidable mode, and a second sliding hole is formed in the right end wall of the third sliding block in a front-back symmetry mode, and a fourth rack is slidably arranged in the second sliding hole, and a first reset device is elastically arranged between the end wall of the fourth rack and the end wall of the third sliding block, and a through hole is communicated between the second sliding hole and the sliding groove, a fifth gear meshed with the fourth rack and the third rack is arranged in the through hole in a rotatable mode, a pushing groove with leftward opening is formed in the top wall of the sliding groove, a sensor electrically connected with the electromagnet is fixedly arranged in the bottom wall of the third rack, a discharging opening communicated with the outside is formed in the right end wall of the sliding cavity, and a second resetting device is elastically arranged between the third sliding block and the upper and lower end walls of the sliding cavity.
